(19) United States
(12) Patent Application Publication
(10) Pub. No.: US 2003/0142676 A1
(43) Pub. Date: Jul. 31, 2003

(54) Method and apparauts for admission control in packet switch

(76) Inventors: Raymond Zeisz JR., Cary, NC (US); Michael Baucom JR., Apex, NC (US)

Correspondence Address: Michael G. Savage, BURNS, DOANE, SWECKER & MATHIS, L.L.P., P.O. Box 1404, Alexandria, VA, 22313-1404, US

(21) Appl. No.: 10/056,735

(22) Filed: Jan. 25, 2002

(51) Int. Cl. H04L 1/00

(52) U.S. Cl. 370/395.1; 370/413

(57) ABSTRACT

Intelligent admission control is achieved in a packet switch while minimizing the reduction in throughput. An array of limit values is stored in a memory of the switch and is accessed according to an indexing scheme. As each packet is received, an index is created and an associated limit value is retrieved for a one-step comparison with a corresponding status value read from a hardware register of the switch to determine whether or not to admit the packet. Accordingly, the number of conditional branches implemented in the microcode is greatly reduced and the packets are processed faster, which results in an increased throughput in the switch. An optional second comparison can be made based on a corresponding probability value stored in the array (with each limit value) before discarding a packet. A random number is compared to each probability value to determine whether to admit the associated packet.

### BACKGROUND

The present invention relates generally to the switching of data packets, and more particularly to efficiently controlling the admission of packets into packet switches.

In a packet data network, e.g., the Internet, packet switches and/or routers are used to direct ATM, Ethernet, and Internet Protocol (IP) data packets based on embedded information. The embedded information may be a packet address that is a part of the format of the packet itself. A packet switch is a multi-port device that forwards inbound packets to a particular port only if that port provides a connection to the next destination of the packet. Packet switching prevents a port or segment of the network from receiving packets that are not addressed to any host or terminal connected to that particular port. In packet switching, packets are generally not transmitted to all ports of the switch, but only to those which lead to hosts involved in the relevant communications session. An IP router performs these functions for IP packets, which correspond to layer 3 in the in the OSI reference model. For the purposes of the present invention, the term “switch” is used to identify with both a packet switch and an IP router.

In existing systems, packets may be prioritized so that packets requiring real-time delivery may be assigned a relatively higher priority so that they are processed before lower priority packets that do not need real-time delivery. Packets may also have assigned schedules to guaranteed delay and bandwidth traffic, as discussed in published U.S. application Ser. No. 2001/0036181 A1.

FIG. 1 illustrates a switch 100 between a first host terminal 110 and a second host terminal 120. Each of the host terminals 110 and 120 are operable to transmit and/or receive packets and are connected to one of a plurality of ports of the switch. In general, the host terminal 110 transmits a packet over a communication link 115 to a port of the switch. The switch 100 may be embodied using interfaces to a wide variety of communication channels or links, including, but not limited to, 10 megabit/second, 100 megabit/second and gigabit, and 10 gigabit Ethernet networks. The switch 100 may also employ interfaces to what are conventionally referred to as “OC”, “DS”, “T”, “E” and other fiber-based or wireless-based links or channels associated with the SONET (Synchronous Optical NETwork) and SDH (Synchronous Digital Hierarchy) communications standards, and suitable for transmitting Internet or Ethernet packets. Accordingly, the disclosed system does not require interfaces to any particular type of communications link. For purposes of illustration, reference is made herein to an embodiment using standard Ethernet interfaces, although a switch made in accordance with the disclosed system may include interfaces of other kinds.

After reception at the switch 100, the packet is carried into a transmit/receive logic (TR) 140 associated with the ingress port. TR 140 operates to extract the packet's destination address and to place the packet's contents into a packet queue 145. The TR 140 sends a query to a switch control CPU 160, which contains the packet destination address. The CPU 160 takes the packet destination address, which consists of both an Ethernet MAC (Media Access Controller) address and an IP address, and uses the packet destination address to determine an egress (destination) port number indicating which port the packet should be transmitted to. The CPU 160 typically determines the egress port number by checking a network look-up table 170, which is continually updated.

Once the CPU 160 has identified the correct egress port number, the CPU 160 checks an internal memory table to determine if the egress port TR 150 is in use. The egress port TR 150 may be busy receiving a packet from another source. If the egress port TR 150 is in use, then the CPU 160 may store the request in a queue and waits for the next request. If the egress port TR 150 is not in use, then the CPU 160 instructs a switch fabric (SF) 130 to set up a connection between the ingress TR 140 and the egress TR 150. As soon as this connection is complete, the CPU 160 sends a message to the ingress TR 140. This message instructs TR 140 to send the packet to the SF 130, which routes the packet to the egress TR 150. The TR 50 will immediately begin transmission of the packet to the host terminal 120 or store the packet in an associated packet queue 155 for later transmission.

The functionality provided in the switch 100 of FIG. 1 may also be realized in whole or in part using software or firmware executing on one or more high-speed processors. FIG. 2 illustrates a switch having a number of high-speed processors, which are optimized to operate on Ethernet and/or Internet Protocol packets, called “network processors” (NP). These NPs 240, 250 direct the flow of packets through the switch. Packets typically enter and leave the NP 240, 250 via integrated high-speed interfaces. These interfaces can be configured as Ethernet or SONET or T-Carrier interfaces by means of a one or more programmable RISC (Reduced Instruction Set) interface engines. An internal Control CPU sets the operating configurations of the RISC engines. The internal Control CPU loads micro-code into the RISC Engine upon start-up of the NP 240, 250.

Each NP 240, 250 can have multiple ports, for both transmit and for receive. The NPs 240, 250 operate to extract the packet's destination address to query to a switch routing CPU 260, which contains the packet address of the destination. The routing CPU 260 takes the packet address, which consists of both an Ethernet MAC (Media Access Controller) address and an IP address, and uses the packet address to determine an egress NP and port number indicating which port the packet should be transmitted to. The routing CPU 260 typically determines the egress port number by checking an internal look-up table, which is continually updated. Packets are transferred from an ingress NP 240 to an egress (destination) NP 250 using the address and associated port of the egress NP 250 via the SF 230. A typical switch may have many ports on many NPs 240, 250.

The internal control CPU in each NP 240, 250 controls the operation of the components of the NP 240, 250, in accordance with the micro-code. It also communicates with a respective external control CPU 245, 255, which works in conjunction with the routing CPU 260 to route packets through the switch fabric 230.

Multiple network processors 240, 250, etc., are used in conjunction with one or more switch fabrics 230 to move packets in and out of the switch 200. The switch operation is controlled via the routing CPU 260, which communicates with other packet switches in order to learn the topology of the network of switches. The routing CPU 260 provides routing information to the NPs 240, 250, etc., so that they can send the incoming packets to the proper output port.

In a shared memory type packet switch, the switch fabric comprises in whole or in part a common memory for buffering packets destined for an output port. The common memory may also be divided into Threshold Groups (TG), which prevent any one port and/or stream from consuming all of the fabric memory. Typically, one TG would be used for each class of service. In effect, the TGs are logically separate pieces of fabric memory, which are statically committed to a particular class of service at boot time.

Use of a shared pool of memory provides an efficient use of the memory and creates an opportunity for more effective and sophisticated congestion management in the switch. Prior art switches generally measured congestion only crudely, either measuring congestion on just a physical device basis, such as discarding buffered packets when shared buffers are full, or according to just one or a few parameters of the switch, such as the priority of the packets. Determining whether or not to admit a packet into the switch fabric is known as admission control.

Admission control is an important characteristic that affects overall performance of the network served. It is desirable for a switch to make intelligent decisions about which packets should be dropped due to congestion. These decisions are typically made by a control CPU using instructions implemented in microcode. For example the control CPU 245, 255 of FIG. 2 can include microcode instructions for performing admission control for the respective ingress port(s) using information relating to the state of congestion in the switch and other important factors, e.g., priority of packets.

An admission control algorithm may be employed that considers multiple inputs parameters to intelligently decide which packets should be injected into the switch fabric and which should be discarded, thereby providing dynamic ingress throttling of traffic in the network. Intelligent admission control decisions are made, for example, based on priority, global fabric utilization, and ingress port usage.

A priority based admission decision involves classifying each packet according to a priority, such as class of service. For example, voice packets are generally given a higher priority class of service than data packets. Each port has multiple Priority-based Fabric Fullness Thresholds (PFFT) at which point no more packets for a given priority will be admitted. For each packet, the microcode compares an admitted register value that stores the number of admitted packets for the given port and priority to the respective PFFT. If the admitted register value is greater than the PFFT, then the packet is discarded. The PFFT does not necessarily have to be on a per port basis. For some applications a PFFT per priority only is acceptable.

A global fabric utilization admission decision involves ensuring that the global fabric utilization is not too high. Once a packet has passed the test for priority-based admission, the microcode performs a simple comparison between a Global Packet Count Register (GPCNT) that stores the number of packets, or cells, admitted into the fabric, and a Global Fabric Utilization Threshold (GFUT). If the fabric has less than GFUT packet buffers free (e.g., 2000), then the microcode must continue to the next decision to ensure that no one ingress port is dominating the fabric. If the fabric is only lightly utilized (e.g., there are more than GFUT packets free), then the microcode immediately jumps out of the admission control logic and injects the packet into the fabric.

An ingress port usage rejection decision is performed when a packet has passed the test for priority-based admission, but the fabric is heavily utilized. The decision is necessary to ensure that a given ingress port is not dominating the fabric usage. This is accomplished by comparing each respective port's ingress fabric buffer usage count (IFBUC). If the IFBUC value is greater than an Ingress Port Rejection Threshold (IPRT), then the microcode must discard the packet. This will ensure that a given ingress port can make maximum usage of the fabric, up to a point, at which time the ingress port is “slowed down” to ensure that other ports may also inject packets into the fabric.

While admission control is an important function for controlling congestion, it is also desirable to maximize the throughput of the switch. To this end, the admission control procedures performed on incoming packets should be performed as quickly and efficiently as possible. However, the more intelligent the admission control procedures are, the greater the number of steps and decisions, i.e., lines of microcode, that must be employed. This tradeoff has generally led to sacrificing admission control intelligence for increased throughput.

Accordingly, there is a need to provide intelligent admission control while minimizing the reduction in the throughput of a switch.

### SUMMARY

The present invention addresses these and other concerns. The admission control procedure is streamlined to process incoming packets as quickly and efficiently as possible.

As can be appreciated from the prior art, multiple conditions must be satisfied to determine whether or not to admit (or discard) a packet when using intelligent admission control. These conditions are typically tested by extensive microcode implementing multiple conditional branches. However, each conditional branch adds to the processing time of each packet, thereby reducing throughput.

According to the present invention, intelligent admission control is achieved while minimizing the reduction in throughput. A Unified Admission Control Algorithm (UAC) is employed that minimizes the number of conditional branches in the microcode. A large multidimensional array of limit values is stored in a memory of the switch and indexed to allow the microcode to quickly determine whether or not to admit each packet into the fabric. The memory storing the array is preferably located on each network processor.

The entries in the memory array are limit values and are accessed according to a index for each packet. As each packet is received, an index is created and an associated limit value is retrieved for a one-step comparison with a corresponding status value read from a hardware register of the switch to determine whether or not to admit the packet. Using this technique the number of conditional branches implemented in the microcode is greatly reduced and the packets are processed faster, which results in an increased throughput in the switch. By carefully arranging and indexing the limit values into the array, very specific drop profiles can be achieved.

An optional second comparison can be made before discarding a packet. This second comparison is based on a corresponding probability value stored in the array with each limit value. A random number is compared to each probability value to determine whether to admit the associated packet.

According to one aspect, a method for selectively discarding packets at a packet switch arranged to handle packet traffic in a network includes building an index for an arriving packet, accessing a location in a memory array according to the index to read at least a limit value from the location, comparing the limit value with a status value of the switch, and determining whether to discard the packet according to the limit value comparison. The packet may then be discarded according to the limit value comparison.

In lieu of discarding the packet according to the limit value comparison, a second comparison may be made. A probability value may optionally be read from the location in the memory array and, if it is determined that the packet should be discarded according to the limit value comparison, then the probability value is compared with a random value and the packet is discarded according to the probability value comparison.

In another aspect, an admission control apparatus for selectively discarding packets at a packet switch arranged to handle packet traffic in a network, the packet switch including a plurality of ingress ports, a switch fabric, and a plurality of egress ports, includes processing means that process an incoming packet and build an index for the packet, memory means that store an array, the array having a plurality of locations, each location storing at least a limit value, a respective location being accessed according to the index to read at least the limit value from the location and comparing means that compare the limit value with a status value of the switch and determine whether to discard the packet according to the limit value comparison. The packet may then be discarded by a packet discard means according to the limit value comparison.

In lieu of discarding the packet according to the limit value comparison, a second comparison may be made. A probability value may optionally be stored in the memory means and read from the location in the memory means. The comparing means then compares the probability value with a random value when it is determined from the limit value comparison that the packet should be discarded. A packet discard means discards the packet according to the probability value comparison.

In yet another aspect, an admission control apparatus for selectively discarding packets at a packet switch arranged to handle packet traffic in a network, the packet switch including a plurality of ingress ports, a switch fabric, and a plurality of egress ports, includes logic that builds an index for an arriving packet, logic that accesses a location in a memory array according to the index to read at least a limit value from the location, logic that compares the limit value with a status value of the switch, and logic that determines whether to discard the packet according to the limit value comparison. The packet may then be discarded according to the limit value comparison.

In lieu of discarding the packet according to the limit value comparison, a second comparison may be made. The apparatus may optionally include logic that reads a probability value from the location in the memory array and logic that, when it is determined that the packet should be discarded, compares the probability value with a random value and discards the packet according to the probability value comparison.

### BRIEF DESCRIPTION OF THE DRAWINGS

The above and other objects, features, and advantages of the present invention will become more apparent in light of the following detailed description in conjunction with the drawings, in which:

FIG. 1 is a block diagram illustrating a conventional packet switch;

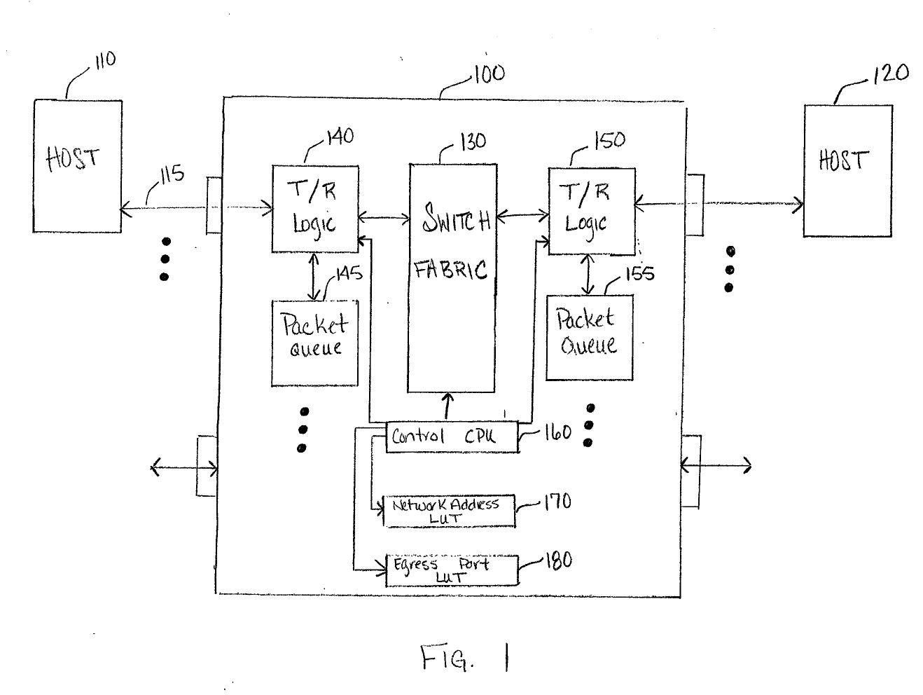

FIG. 2 is a block diagram illustrating a conventional packet switch utilizing network processors;

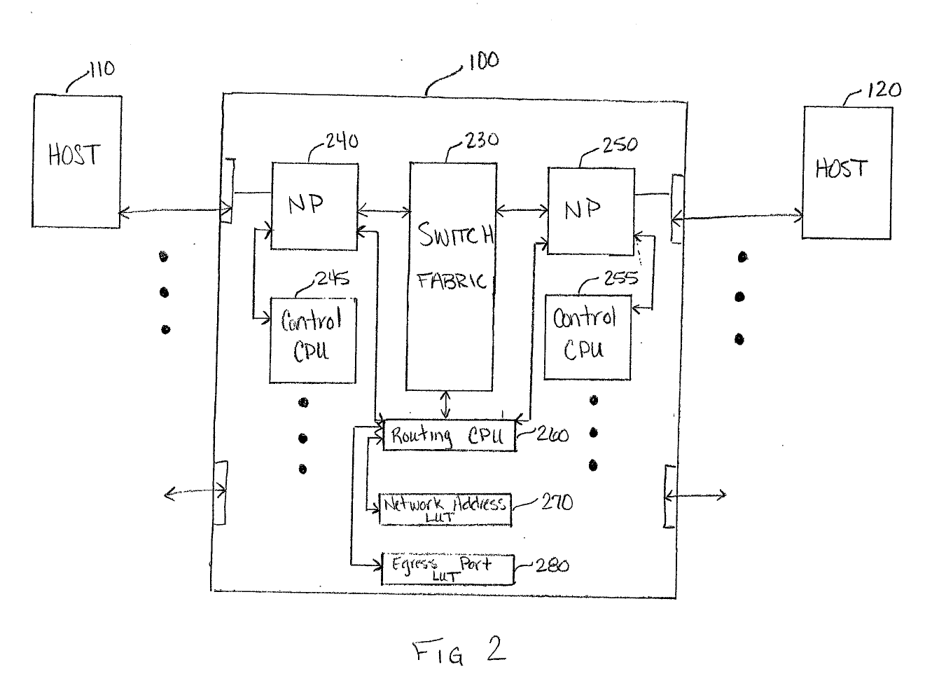

FIG. 3 illustrates an array for storing limit values according to the invention;

FIG. 4 illustrates an index being built by gathering and concatenating bits from various input parameters known to the switch at the time the packet is processed according to the invention;

FIG. 5 is a flow chart illustrating an admission control procedure according to a first embodiment of the present invention;

FIG. 6 graphically illustrates a two-dimensional drop profile;

FIG. 7 graphically illustrates a three-dimensional drop profile;

FIG. 8 is a flow chart illustrating an admission control procedure according to a second embodiment of the present invention; and

FIG. 9 illustrates an eight-bit limit value being concatenated with an eight-bit probability value to create one sixteen-bit array element.

### DETAILED DESCRIPTION

Preferred embodiments of the present invention are described below with reference to the accompanying drawings. In the following description, well-known functions and/or constructions are not described in detail to avoid obscuring the invention in unnecessary detail.

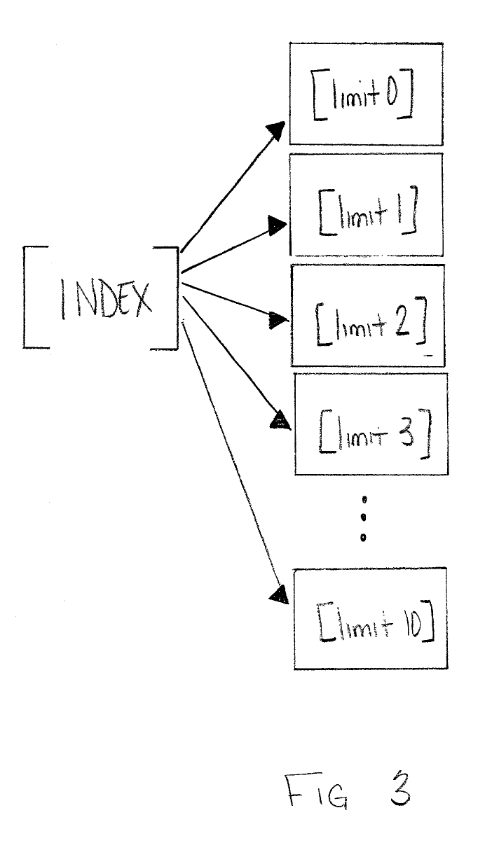

FIG. 3 illustrates a simple array for storing the limits values [limit0] to [limitN]. The limit values are stored in memory and accessed according to the index for each packet. The memory is preferably located in each respective NP of the switch for fast access by the microcode, but may be located elsewhere in the switch. The array will increase in dimension as the input parameters are increased, but the concept is the same. By creating an index for each packet, an associated limit value can be retrieved for a one-step comparison with a corresponding hardware register to determine whether or not to admit the packet. Using this technique the number conditional branches implemented in the microcode is greatly reduced. That is, when only the limit value is considered, only one comparison is made, which streamlines the admission control procedure. Consequently, the packets are processed faster, which results in increasing the throughput of the switch.

The array can be built at system boot time and loaded into the memory(s) via applets or memory writes. The array is preferably read-only from the microcode's point of view, but may also be updated during run-time with minimal impact to the switch's performance.

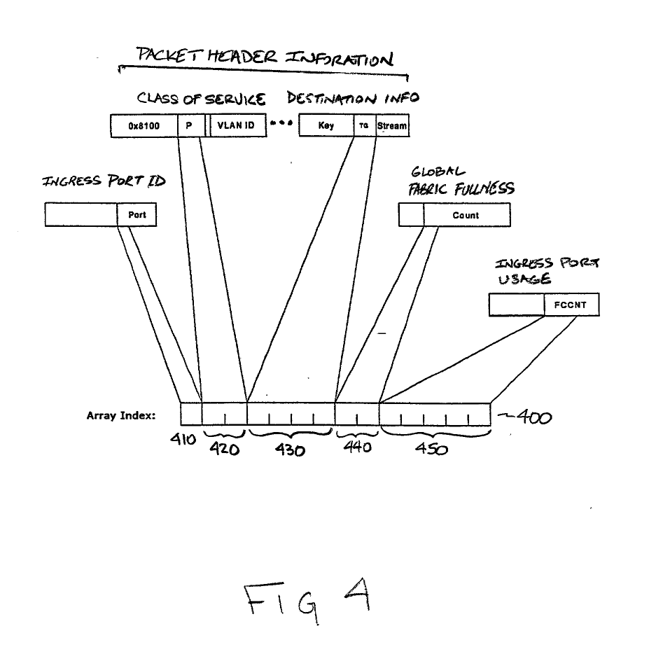

When a packet is received a corresponding index is built. Referring to FIG. 4, the index is built by gathering and concatenating bits from various input parameters known to the switch at the time the packet is processed. For example, FIG. 4 illustrates a fourteen-bit index 400 built by concatenating one bit from the Ingress Port Identifier to represent the Ingress Port Type 410, two bits read from the packet's header that identify one of four possible Packet Class of Services 420, four bits of destination information read from the packet's header that identify one of sixteen Threshold Group Numbers 430, the two most significant bits of a register value representing the Global Fabric Fullness 440, and the five most significant bits of a register value representing the Ingress Port Usage 450. The index can be built quickly by simple concatenation of known bits with minimal impact to admission control processing time. It should be recognized that many other parameter/bit combinations are possible for building the index, of which FIG. 4 provides only one example.

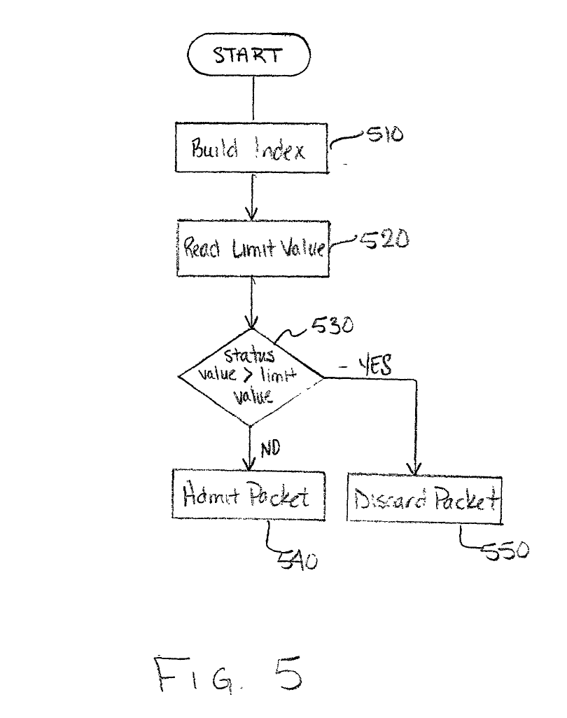

FIG. 5 illustrates the streamlined admission control procedure. Once the index is built (step 510), the associated limit is read from the array (step 520). The index may be added to a base address of the array first, so the index and array start at the same offset in the memory, i.e., the first index points to limit value [limit0]. Each limit value in the array is a fixed number of bits, e.g., eight bits long. The limit value is then compared (step 530) with all or the most significant bits of a corresponding hardware register that maintains a particular status value of the switch. Depending on the exact behavior and requirements, the status value could, for example, be a measure of one or more of the following: the ingress port's current consumption, the destination threshold group's current consumption, and the current global fabric fullness.

For example, if the limit values used in the array in a particular implementation are based on global fabric fullness, then the limit value in the array is compared to the most significant bits of a Global Cell Descriptor Count Register (GCDCR), which identifies the additional number of cells that the fabric can currently accommodate. In this case the GCDCR represents the status value. If, upon comparison, the GCDCR indicates that fewer than the read limit value number of cells can be added to the fabric, then the packet is discarded (step 550), otherwise the packet is admitted (step 540).

In another example, the limit values used in the array may be based on destination threshold group consumption. The limit value in the array can then be compared to the Group Cell Count Register (GCCR), which identifies the additional number of cells that the respective threshold group can currently accommodate. In this case the GCCR represents the status value. If, upon comparison, the GCCR indicates that fewer than the read limit value number of cells can be added to the threshold group, then the packet is discarded (step 550), otherwise the packet is admitted (step 540).

As can be appreciated, many other status values of the switch may be considered. The status value is preferably stored and maintained (updated) in a hardware register. The size of the status value may be greater than the size of the limit value, in which case only the most significant bits of the status value need be considered.

By carefully arranging and indexing the limit values into the array, very specific drop profiles can be achieved. For example, if the packet's class of service were taken into account when indexing the array, then the limit values would become increasingly tight in the array entries as priority decreases, all else being equal. Careful consideration must be used when choosing the limit values on which to make the drop decision. This set of values will provide a corresponding drop profile, i.e., an overall scheme for the discarding of packets. Once the array values are selected, and a corresponding drop profile is adopted, much of the repetitive decision making is done up front, allowing the admission control function to be performed much more efficiently.

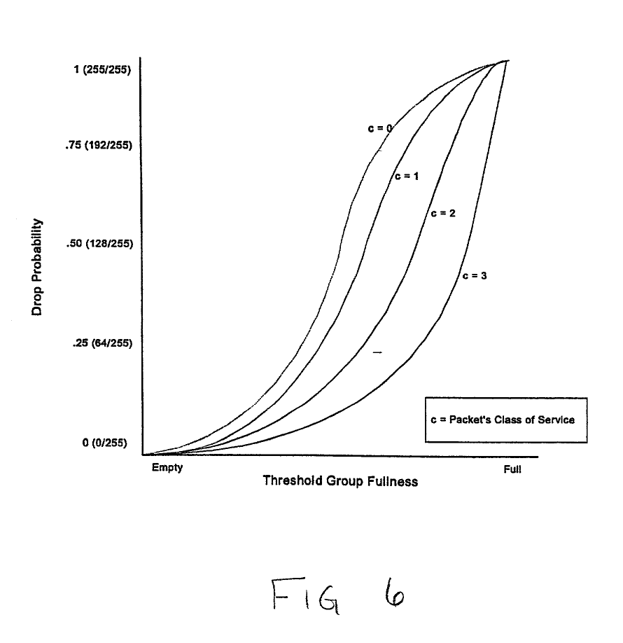

FIG. 6 graphically illustrates a two-dimensional drop profile that is based on the Packet's Class of Service and the Threshold Group Fullness. As the Class of Service increases (i.e., packets are more important) the likelihood of packet discard is reduced. As the TG fills, the likelihood of any packet being dropped approaches unity.

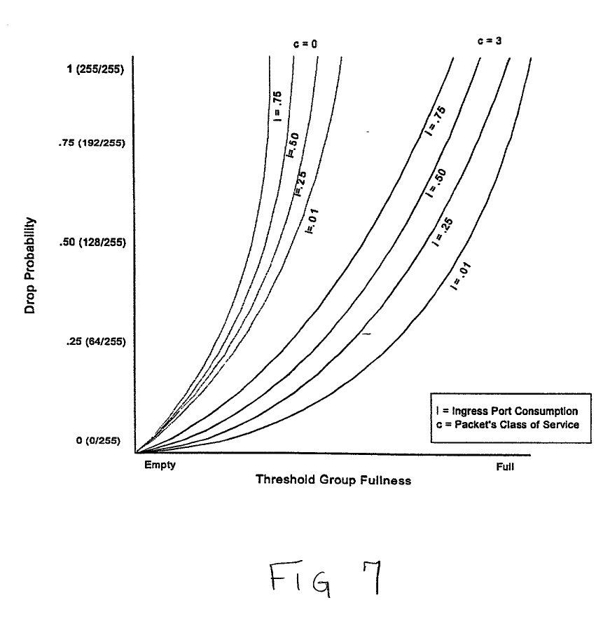

FIG. 7 graphically illustrates a three-dimensional drop profile. The drop profile is based on the Ingress Port's Fabric Usage, in addition to the Packet's Class of Service and the Threshold Group Fullness. To reduce the complexity of the graph, only two of the four Classes of Service are shown. As can be seen, packets are discarded more aggressively at the lower classes of service and as the ingress port's consumption increases.

In another embodiment, the UAC is further enhanced by adding an associated probability value to each of the limit values in the array. Here, each entry in the array is no longer just a limit for discard, but rather a limit plus a probability for discard. The probability values are determined and indexed into the array by considering data provided by the UAC input parameters used to build the index. For example, a Random Early Discard (RED) probability scheme can be used.

RED is a congestion control scheme that monitors the average queue size for each output queue, and, using randomization, chooses which connections to notify of that congestion, e.g., which packets to discard. The randomization allows transient congestion, such as traffic bursts, to temporarily admit packets, while longer-lived congestion is reflected by an increase in the computed average queue size, and results in randomized packet discard. The probability values in the array can correspond to the average queue size as established by the indexing scheme. The probability values associated with a port or connection is proportional to that connection's share of the throughput through the switch. Additional details about RED can be found in “Random Early Detection Gateways for Congestion Avoidance,” Sally Floyd and Van Jacobson, IEEE/ACM Transactions on Networking, August 1993.

Once the probability values are established, a random number is needed for comparison to the probability value to provide the randomization. A value read from a timer register of the switch is preferably used. Reading the least significant bits of the timer register provides an easily available quickly changing number that appears random for our purposes. For example, where an eight-bit probability value is used, the eight least significant bits of the timer register are read for comparison. Many other techniques can be used to further randomize the timer register number, such as multiplying or masking the number with another changing register value, such as one of the register values described above. In addition, sources other than the timer register value can be used to provide the random number for comparison.

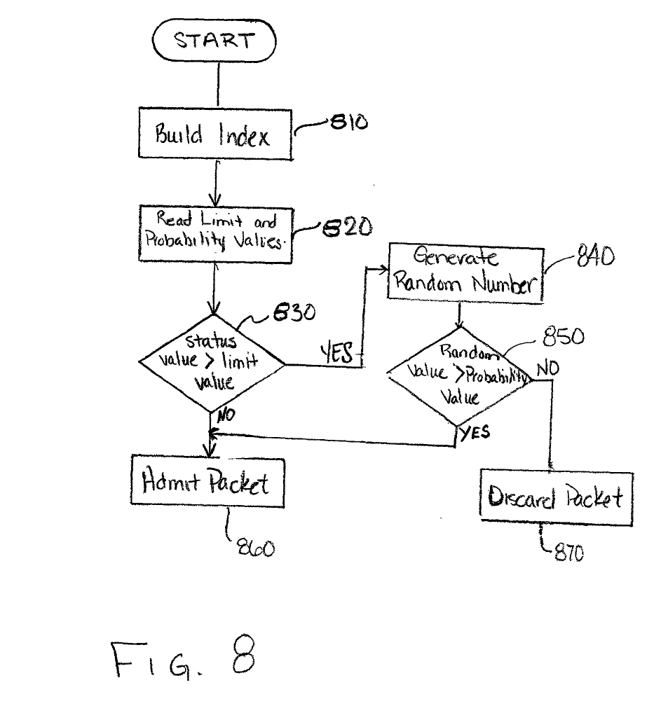

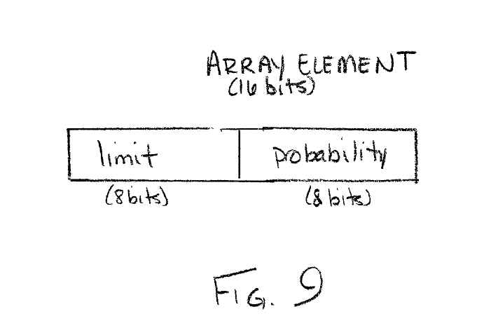

FIG. 8 illustrates an admission control procedure using limit values and probability values according to the second embodiment. Referring to FIG. 8, after the UAC index is built (step 810) for a packet, the corresponding limit and probability values are read (step 820). This value may be stored as one value as illustrated in FIG. 9, where, for example, an eight-bit limit value is concatenated with an eight-bit probability value to create one sixteen-bit value. Once the values are read from the array, a one or two-step comparison is made. The limit value is compared (step 830) with all or the most significant bits of a corresponding hardware register that maintains a particular status value of the switch, as described above. If, upon comparison, the status value does not exceed the read limit value, then the packet is admitted (step 860). If, however, the status value exceeds the read limit value, then a second comparison is performed before discarding the packet.

For the second comparison, the microcode generates a random number (step 840), e.g., from the timer register, and compares (step 850) that value to the read probability value. If the random value is larger than the probability value, the packet is admitted (step 860). Otherwise, the packet is discarded (step 870).

It will be appreciated that the steps of the methods illustrated above may be readily implemented either by software that is executed by a suitable processor or by hardware, such as an application-specific integrated circuit (ASIC).

The various aspects of the invention have been described in connection with a number of exemplary embodiments. To facilitate an understanding of the invention, many aspects of the invention were described in terms of sequences of actions that may be performed by elements of a computer system. For example, it will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A method for selectively discarding packets at a packet switch arranged to handle packet traffic in a network, the method comprising the steps of:
(a) building an index for an arriving packet;
(b) accessing a location in a memory array according to the index to read at least a limit value from the location;
(c) comparing the limit value with a status value of the switch; and
(d) determining whether to discard the packet according to the limit value comparison.

2. The method of claim 1, wherein in step (b), a probability value is also read from the location in the memory array and, in step (d), if it is determined that the packet should be discarded, then the method comprises the additional steps of:
(e) comparing the probability value with a random value; and
(f) discarding the packet according to the probability value comparison.

3. The method of claim 1, comprising the additional step of discarding the packet according to the limit value comparison.

4. The method of claim 1, wherein in step (a), the index is built by concatenating bits read from a plurality of parameters relating to header information in the packet and status information of the packet switch.

5. The method of claim 4, wherein the parameters include one or more of an Ingress Port Identifier, a Packet Class of Service, a Threshold Group Number, a Global Fabric Fullness, and an Ingress Port Usage.

6. The method of claim 1, wherein in the status value of the switch is read from a hardware register of the switch.

7. The method of claim 1, wherein in the status value of the switch is one of an ingress port current consumption value, a destination threshold group current consumption value, and a current global fabric fullness value.

8. The method of claim 2, wherein the probability values are determined according to a scheme with a random event aspect to avoid traffic congestion.

9. The method of claim 2, wherein the random value is based on a timer value of the packet switch.

10. An admission control apparatus for selectively discarding packets at a packet switch arranged to handle packet traffic in a network, the packet switch including a plurality of ingress ports, a switch fabric, and a plurality of egress ports, the admission control apparatus comprising:
processing means that process an incoming packet and build an index for the packet;
memory means that store an array, the array having a plurality of locations, each location storing at least a limit value, a respective location being accessed according to the index to read at least the limit value from the location; and
comparing means that compare the limit value with a status value of the switch and determine whether to discard the packet according to the limit value comparison.

11. The apparatus of claim 10, wherein a probability value is also stored in the memory means and read from the location in the memory means and the comparing means compares the probability value with a random value when it is determined from the limit value comparison that the packet should be discarded, and further comprising packet discard means to discard the packet according to the probability value comparison.

12. The apparatus of claim 10, further comprising packet discard means to discard the packet according to the limit value comparison.

13. The apparatus of claim 10, wherein the index is built by concatenating bits read from a plurality of parameters relating to header information in the packet and status information of the packet switch.

14. The apparatus of claim 13, wherein the parameters include one or more of an Ingress Port Identifier, a Packet Class of Service, a Threshold Group Number, a Global Fabric Fullness, and an Ingress Port Usage.

15. The apparatus of claim 10, wherein in the status value of the switch is read from a hardware register of the switch.

16. The apparatus of claim 10, wherein in the status value of the switch is one of an ingress port current consumption value, a destination threshold group current consumption value, and a current global fabric fullness value.

17. The apparatus of claim 11, wherein the probability values are determined according to a scheme with a random event aspect to avoid traffic congestion.

18. The apparatus of claim 11, wherein the random value is based on a timer value of the packet switch.

19. An admission control apparatus for selectively discarding packets at a packet switch arranged to handle packet traffic in a network, the packet switch including a plurality of ingress ports, a switch fabric, and a plurality of egress ports, the admission control apparatus comprising:
logic that builds an index for an arriving packet;
logic that accesses a location in a memory array according to the index to read at least a limit value from the location;
logic that compares the limit value with a status value of the switch; and
logic that determines whether to discard the packet according to the limit value comparison.

20. The apparatus of claim 19, further comprising logic that reads a probability value from the location in the memory array and logic that, when it is determined that the packet should be discarded, compares the probability value with a random value and discards the packet according to the probability value comparison.

21. The apparatus of claim 19, further comprising logic that discards the packet according to the limit value comparison.

22. The apparatus of claim 19, further comprising logic that builds the index by concatenating bits read from a plurality of parameters relating to header information in the packet and status information of the packet switch.

23. The apparatus of claim 22, wherein the parameters include one or more of an Ingress Port Identifier, a Packet Class of Service, a Threshold Group Number, a Global Fabric Fullness, and an Ingress Port Usage.

24. The apparatus of claim 20, wherein the probability values are determined according to a scheme with a random event aspect to avoid traffic congestion.

25. The apparatus of claim 20, wherein the probability values are determined according to a scheme with a random event aspect to avoid traffic congestion.

26. The apparatus of claim 20, wherein the random value is based on a timer value of the packet switch.
